(19) United States
(12) Patent Application Publication
(10) Pub. No.: US 2010/0264109 A1
(43) Pub. Date: Oct. 21, 2010

(54) CROWN-TYPE METAL CAP WITH PROJECTION INDICATING PRESSURE OR VACUUM, AND METHOD FOR MAKING SAME

(75) Inventors: Jose Antonio Garcia Pedraza, Monterrey (MX); Ramiro Escamilla Garza, San Nicolas de los Garza (MX)

Correspondence Address: MICHAEL WINFIELD GOLTRY, 4000 N. CENTRAL AVENUE, SUITE 1220, PHOENIX, AZ, 85012, US

(73) Assignee: Fabricas Monterrey, S.A.DE C.V., Monterrey, Nuevo Leon (MX)

(21) Appl. No.: 12/517,028

(22) PCT Filed: Dec. 20, 2006
(86) PCT No.: PCT/MX2006/000154

§ 371 Date: May 29, 2009

(51) Int. Cl. B65D 41/12; B23P 25/00

(52) U.S. Cl. 215/328; 29/458

(57) ABSTRACT

A crown-type metal cap comprising a central body; a peripheral crown having a continuous series of grooves forming a single structure with the central body; and a substantially semi-spherical projection in the central body which operates in an original state and in changed state with respect to the central body. A method for manufacturing crown-type metal caps with a projection is also described; the method is characterized in that it comprises the steps of applying at least one coating on at least one side of a metal sheet; cutting and shaping the coated metal sheet into individual crown-type metal caps which include a central body and a peripheral crown provided with a continuous series of grooves forming a single structure; and forming a projection in the central body of each of the metal caps. Methods for bottling pressurized beverages and for bottling vacuum beverages using the crown-type metal caps with projection as per the invention are also described.

### TECHNICAL FIELD OF THE INVENTION

The present invention relates to crown-type metal caps. Particularly, it relates to crown-type metal cap with a projection that operates in an original state and in a changed state in order to serve as an indicator of pressure or vacuum in a bottled beverage.

### BACKGROUND OF THE INVENTION

Currently the caps may be made of metal or plastic material and are used for closing plastic, glass or metal bottles which are used for bottling; for example, food or carbonated or non-carbonated beverages such as: beer, soft drinks, juices, etc. Usually, a cap includes a metal or plastic shell inside which has a liner for sealing hermetically the container and retaining its internal pressure or vacuum.

At present, in the food industry, indicators of vacuum are widely used; these indicators are presented in form of “buttons” or projections, which are deformed depending on certain conditions of closing the container through the caps. These indicators are very effective means of rapid detection that allow knowing some very important conditions of the container and the product. For example, for food or beverages packed in vacuum, where the projection or “button” is in concave or in a “downward” position; this may indicate that the container is hermetically closed and that its product is in optimal consumption conditions. On the other hand, if the projection or “button” is in convex or “upward” position, this indicates that the container has been opened or handled improperly or that the product is deteriorated.

Examples of the current practices for elaborating caps with projection for products packed in vacuum can be found in the following patent documents:

Peter A. Vercillo, Anthony J. Pfeiffer, and Joseph J. Janisch Jr., in the Spanish patent ES-2069828, describe closure caps which have indicators of improper handling in the form of buttons or zones of the panel, which deform depending on the conditions determined by the closure of the container by closure caps. Concretely, it refers to a change in the structural form of the button or panel zone of closing for intensifying the energy stored in it and increasing the energy substantially.

Daniel M. Carson, in the Mexican patent MX-173821, describes a closure that makes evident the improper handling. It consists in a closure that includes an end panel incorporating the same an indicative button of tampering, an external coating on said button including breakable capsules containing a colorant. Said closure is enhanced by layer of translucent material supported by the end panel and that contains the button, said translucent layer that forms a wall against which said button will perform a clash of these capsules to break the capsules, and there is a space between the capsules, spacers of a size greater than that of the capsules to avoid any accidental rupture of the capsules.

Robert J. Heilman, in the Mexican patent MX-177570, describes the closure for a container that forms a closing cap that is provided with a button that functions mechanically. The button is surrounded by a plurality of curved areas, that when applying the closure results in an annular portion of closure that surrounds the button to invert and project the button axially upward from its original position of release to a projected position. The closure may improve by another tapered arrangement indicating that the closure is sealed by a transparent panel that lies on top of the end panel of the closure, and that is united at its periphery to the closure. The transparent panel will have a layer of material generally axially aligned with the button and the latter will be provided with an adhesive layer, preferably a contact adhesive. The layer of material carried by the transparent panel may be formed by fragile material or can be removed from the transparent panel, whether to remove either a message or make a message visible.

Peter A. Vercillo, Anthony J. Pfeiffer and Joseph J. Janisch Jr., in the Mexican patent MX-180204, describe a closure cap for containers packed under vacuum, in which said closure includes a metal end panel that is axially movable from an indicator position to an indicator position of non-vacuum. Said end panel includes generally a flat part centrally located which extends radially outward into an annular portion, and said annular portion includes a plurality of regions circumferentially spaced.

William J. Kapolas, Peter A. Vercillo, Daniel Dowling, George S. Beatovic, Oscar N. Clifton, Roland Gatz, Eugene W. Harford, Chester Wilczenski, John Dobbs, Roland Kowalczyk, Derek G. Owen and John N. Banich, in the Mexican patent MX-186118, describe a closure cap; said closure cap is shaped like a shell of metal sheet configured in a way that includes an outer skirt that has in one of its top edges, an annular channel that opens downward to receive sealant and an end panel reduced into the canal; the end panel has mainly the form of a tampering indicator button activated by vacuum; the button includes a radially outer annular flange that is tilted upward and which has an elevation; an annular intermediate flange that is inclined upward and that has a depression, and that is linked to the outer rim by a first radius and a central portion which is inclined upwards, linked to the intermediate rim with a second radius. The central panel can be moved axially downwards under the influence of vacuum in the end panel so that it has a downward inclination.

A current variation of the solutions described in the former patents, is to reverse the operation of the button or indicator projection in the cap for use in packing pressurized beverages, as described by Steven T. Cook, Mark F. Broerman and Dale R. Conley in the publication of the American patent application US-2005/0051554, which describes an improvement to the cap and an apparatus and method for the embodiment of the same. The cap is provided with a central button on the top panel, which can be moved up or down in relation to the top panel. When the cap is sealed to the container inside which there is pressurized liquid, the button moves up respect to the top panel where the button was in an initial state in downward position respect to the top panel.

The solutions described above are only able to close or tap containers or wide-mouth bottles, that is, they are not suitable for small mouth bottles that need to be closed with crown-type metal caps, as the functionality and manufacturing process of conventional cap, described in the patent documents cited, with respect to functionality and manufacturing process of a crown-type metal cap is to be different. For example, in the conventional container cap or wide-mouth bottle, the projection or button is formed during the fold and then the liner that will, in general, be placed on the interior rim of the shell is formed; while in the manufacture of a crown-type metal cap it will be very difficult to form a liner that meets the functional requirements, if the shell shows some distortion or bulge as the result of a previous manufacturing stage when entering the stage of forming the seal.

Another limitation of the crown-type metal caps is that consumers do not know if the product packed under pressure or vacuum, using this type of caps, was handled incorrectly and/or meets the required quality for consumption. Additionally, the manufacturer of bottled beverages does not have any visual, auditive or tactile indicator of the product showing whether the beverage was sealed hermetically.

In view of the above and to offer a solution to the limitations found in the current crown-type metal caps, it is necessary to provide a crown-type metal cap with a pressure or vacuum projection indicator for beverages bottles under pressure or vacuum as well as a method of manufacturing of the same, so that this projection is a visual, tactile and/or auditive indicator of the conditions of the product to the consumer and the manufacturer.

### SUMMARY OF THE INVENTION

In view of the above and with the aim of solving the limitation found in the crown-type caps, it is the object of this invention to provide a crown-type metal cap formed by a central body; a peripheral crown provided with a continuous series of grooves forming a single structure with the central body, and a projection in the central body that operates in an original state and in a changed state, with respect to said original state.

Another object of this invention is to provide a method for manufacturing crown-type metal caps with a projection. The method comprises the steps of applying at least one coating on at least one side of metal sheet; cutting and shaping the coated metal into individual crown-type metal caps which including a central body and a peripheral crown provided with a continuous series of grooves forming a single structure with said central body; and forming a projection in the central body of each the metal caps.

Also, another object of this invention is to provide a method for bottling pressurized beverages, the method has the following steps: a) feeding a bottling machine with a series of bottles; b) feeding the bottling machine with said beverage; c) feeding to a capping machine with a series of crown-type metal caps with projection, that have a central body; a peripheral crown having a continuous series of grooves forming a single structure with the central body; and a projection in the central body, wherein the projection is in an original state of concave shape with respect to the central body; d) bottling, in the bottling machine, the beverage in the bottles; and e) closing, in the bottle closing machine, each of the bottles with one of the crown-type metal caps with projection, wherein the projection changes to a changed state with respect to the central body, this change is result of the pressure produced by the bottled beverage.

Finally, it is the object of this invention to provide a method for bottling beverages under vacuum, the method comprises the following steps: a) feeding to a bottling machine with a series of bottles; b) feeding the bottling machine with the beverage; c) feeding to a capping machine with a series of crown-type metal caps with projection, that have a central body; a peripheral crown having a continuous series of grooves forming a single structure with the central body; and a projection in said central body, wherein the projection is in an original state of convex shape with respect to the central body; d) bottling, in the bottling machine, the beverage in the bottles; e) closing, in the capping machine, each of the bottles with one of said crown-type metal caps with projection; and f) generating the vacuum in the bottle, wherein the projection changes to a changed state with respect to the central body, this change is result of the existing vacuum in the bottled beverage.

### BRIEF DESCRIPTION OF THE FIGURES

The characteristic details of the invention are described in the following paragraphs together with the figures that can be found herein, which are for the purpose of defining the invention, but without limiting its scope.

FIG. 1 shows a top view of a crown-type metal cap with projection according to the invention. The crown-type metal cap is free, that is, before closing a bottle.

FIG. 2A shows a side sectional view of the first embodiment of a crown-type metal cap with projection according to the invention, once it has been manufactured and before being placed on the mouth of a bottle.

FIG. 2B shows a side sectional view of the first embodiment of a crown-type metal cap with projection of the FIG. 2A, according to the invention, once it has been placed on the threaded mouth of a bottle that contains a pressurized beverage.

FIG. 2C shows a side sectional view of the first embodiment of the crown-type metal cap with projection of the FIG. 2B, according to the invention, at the moment that it has been withdrawn from the bottle or when the beverage has been handled improperly.

FIG. 3A shows a side sectional view of a second embodiment of a crown-type metal cap with projection according to the invention, once it has been manufactured, and before being placed on the mouth of bottle.

FIG. 3B shows a side sectional view of the second embodiment of the crown-type metal cap with projection of the FIG. 3A, according to the invention, once it has been placed on the threaded mouth of a bottle that contains a vacuum bottled beverage.

FIG. 3C shows a side sectional view of the second embodiment of the crown-type metal cap with projection of the FIG. 3B, according to the invention, at the moment it has been withdrawn from the bottle or when the beverage has been handled improperly.

FIG. 4 shows a block diagram of a method for manufacturing a crown-type metal cap with projection according to the invention.

FIG. 5 shows a block diagram of a method for bottling pressurized beverages with crown-type metal caps with projection according to this invention.

FIG. 6 shows a block diagram of a method for bottling vacuum beverages with crown-type metal caps with projection according to this invention.

### DETAILED DESCRIPTION OF THE INVENTION

The term “projection”, in the context of this description, means part which is distinguished from a surface because it is convex or concave shape with respect to the plane of the surface, and/or when being in the same surface plane, there is a mark that limits and distinguishes it.

The term “original state”, in the context of this description, means the initial state in which a projection was manufactured in a crown-type metal cap, so that when the crown-type metal cap is used for bottling pressurized beverages, the projection is manufactured with an initial state in convex shape with respect to the plane of the central body of the metal cap, whereas in the case of bottling vacuum beverages, the projection is manufactured in an initial state in concave shape with respect to the plane of the central body, the former with respect to top view of the crown-type metal cap. The projection tends to return to its original state when the minimum and necessary conditions to maintain a changed state are not met.

The term “changed state”, in the context of this description, means the state to which the projection changes if the conditions are met that allow to bend the form of the original state, so that the projection in its changed state remains generally the same plane of the central body of the crown-type metal cap or an inverse form of the original state. Such that when the crown-type metal cap is used for closing a bottle with pressurized beverage, the projection changes from its original convex shape to a changed state, where the projection usually occupies the same plane of the central body of the crown-type metal cap or acquires a concave shape; whereas in the case the crown-type metal cap used for beverages bottled in vacuum, the projection changes from its original state in concave shape to a changed state, where the projection usually occupies the same plane of the central body of the crown-type metal cap or acquires a convex shape. The changed state will be lost if the minimum and necessary conditions to maintain it are not met, therefore the projection will automatically return to its original state.

This invention relates to a crown-type metal cap with projection, for pressurized or vacuum beverages, where the projection is an indicator of the presence of pressure or vacuum into the bottle. Therefore, the projection allows to detect, in a visual, auditive and/or tactile manner, during the bottling process, if the beverage has been properly bottled and the crown-type metal cap is hermetically sealed to the bottle; on the other hand, this allows the consumer to detect, in a visual, auditive and/or tactile manner, if the bottle or the beverage is in proper consumer conditions, or if it has been handled or handled improperly.

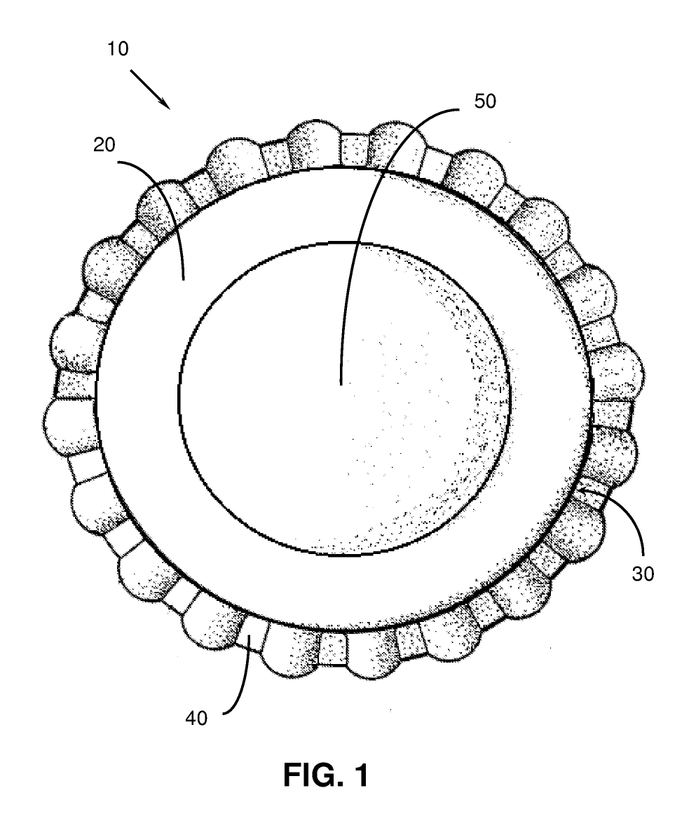

FIG. 1 shows a top view of a crown-type metal cap with projection according to the invention. The crown-type metal cap is shown free, that is, before to close a bottle. The crown-type metal cap 10 is formed by a central body 20; a peripheral crown 30 provided with a continuous series of grooves 40 forming a single structure with the central body 20, so that the crown-type metal cap 10 includes a projection 50, which is generally of semi-spherical shape, in the central body 20 and concentric to this.

The crown-type metal cap 10 with projection according to the invention is made from metal sheets with thickness within a range of about 0.1778 mm (0.007 in) to about 0.26 mm (0.01 in).

The projection 50 operates in an original state and in a changed state, with respect to the central body 20. The projection 50 has a diameter in range of about 6.35 mm (0.25 in) to about 18.415 mm (0.725 in) and is smaller than the diameter of the liner (not shown). The depth or height of the center of the projection 50 with respect to the plane of the central body 20 is within a range of about 0.127 mm (0.005 in) to about 1.778 mm (0.070 in).

The projection 50 generally has a semi-spherical shape in its original state, either concave or convex shape with respect to the plane of the central body 20 depending on the application of the crown-type metal cap 10, so that at the moment that the crown-type metal cap closes a bottle and the minimum or necessary conditions are met so that projection 50 changes to a changed state, where projection 50 obtains, preferably, a shape that is usually located in the same plane of central body 20.

This changed state, where the projection 50 is located in the same plane of the central body 20, apart from serving as a visual, auditive and/or tactile indicator, it is also useful to allow the stowage of boxes with bottles, because if there were a bulge in the central body 20, the weight of the boxes or bottles stowed would cause damage to the inferior bottles bearing the burden.

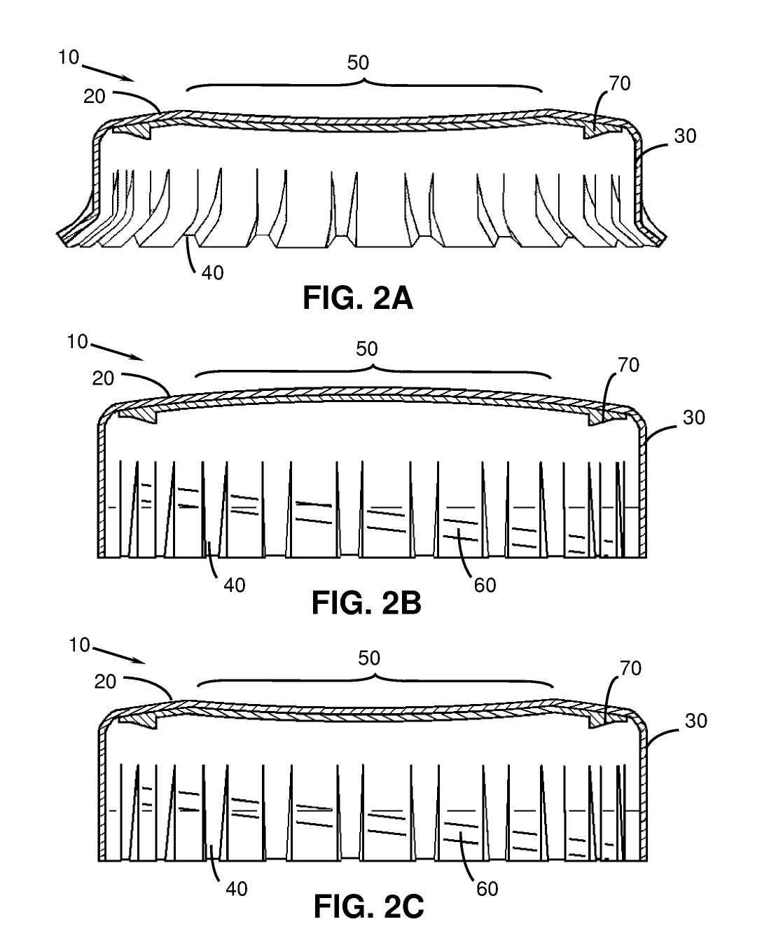

Respect to the FIGS. 2A, 2B and 2C, these illustrate a first embodiment of a sequence of state changes of projection for an application of a crown-type metal cap 10 for closing pressurized beverage bottles.

In the FIG. 2A is illustrated a side sectional view of a crown-type metal cap 10 once it has been manufactured and before being placed on the mouth of bottle, that is, in its free form, which has been manufactured with the projection 50 in an initial state in concave shape with respect to the plane of the central body 20. The crown-type metal cap 10 has a liner 70 and the other elements described in FIG. 1. The projection 50 has a diameter smaller than the diameter of the liner 70 to facilitate its manufacturing, operation, and avoiding interference with the liner 70, with the bottle (not shown) and with the rest of the crown-type metal cap 10.

In the FIG. 2B is illustrated a side sectional view of the crown-type metal cap 10 of the FIG. 2A, once it has been located on the threaded mouth of the bottle (not shown) that contains a pressurized beverage. Product of the closing or crowning process, and in general simultaneously, the projection 50 changes from an original state in concave shape (see FIG. 2A) to a changed state generally in the same plane of the central body 20, this due to the pressure by the beverage on the inner surface of projection 50, creating a characteristic sound similar to “click”, “pop” or “clack”, a visual appearance of projection 50 similar to a mark, generally in circular shape on the surface of central body 20, and a smooth feeling without protuberances when touching projection 50 and central body 20.

In an alternative embodiment, the projection 50 in its changed state can obtain an inverse shape to the shape of the original state, that is, if the original state is of concave shape, the changed state becomes the convex shape with respect to the plane of central body 20.

The changed state is maintained as long as there is enough pressure inside the bottle, over the effort exerted by projection 50 when trying to recover its initial state in concave shape. The pressure inside the bottle to maintain the changed state of projection 50 is within a range of about 68.9475 kPa (10 psi) to approximately 1378.9514 kPa (200 psi).

In this embodiment, the changed state is a visual, auditive and tactile support to the consumer of the product, because it indicates that the beverage is in proper conditions for consumption, that is, in case the bottle shows its crown-type metal cap 10 with the projection 50 in its original concave shape, this is a signal to consumers that the beverage has been handled improperly, or that is not optimal conditions of consumption, or alternatively, it may be an indicator for monitoring quality during the process of bottling, as it would be an indication that there is a leakage of gas from the beverage as it is not hermetically sealed by the crown-type metal cap 10 on the bottle.

Alternately, during the process of capping or crowning, in the crown-type metal cap 10, particularly in the interior of the peripheral crown 30, a threading 60 is formed, thus producing crown-type metal cap 10 in accordance with this invention, but with the “twist-off” function.

FIG. 2C shows a side sectional view of the crown-type metal cap 10 of the FIG. 2B at the moment it has been withdrawn from the bottle or when the beverage has been handled improperly. Under these conditions, the projection 50 automatically changes from a changed state to the original state in concave shape with a characteristic sound similar to “click”, “pop” or “clack”, a visual appearance of the projection 50 in concave shape on the surface of central body 20 and a sinking feeling or with protuberances when touching projection 50 with respect to the central body 20. This is due to that the pressure on projection 50 has decreased to the extent that it does not prevent projection 50 to recover its original state in concave shape. The visual change of projection 50, with respect to the central body 20, from a changed state to an original state in concave shape indicates that the bottle has been opened or perhaps the gas is leaked from the bottle, and additionally, the sound similar to “click”, “pop” or “clack” will provide another signal.

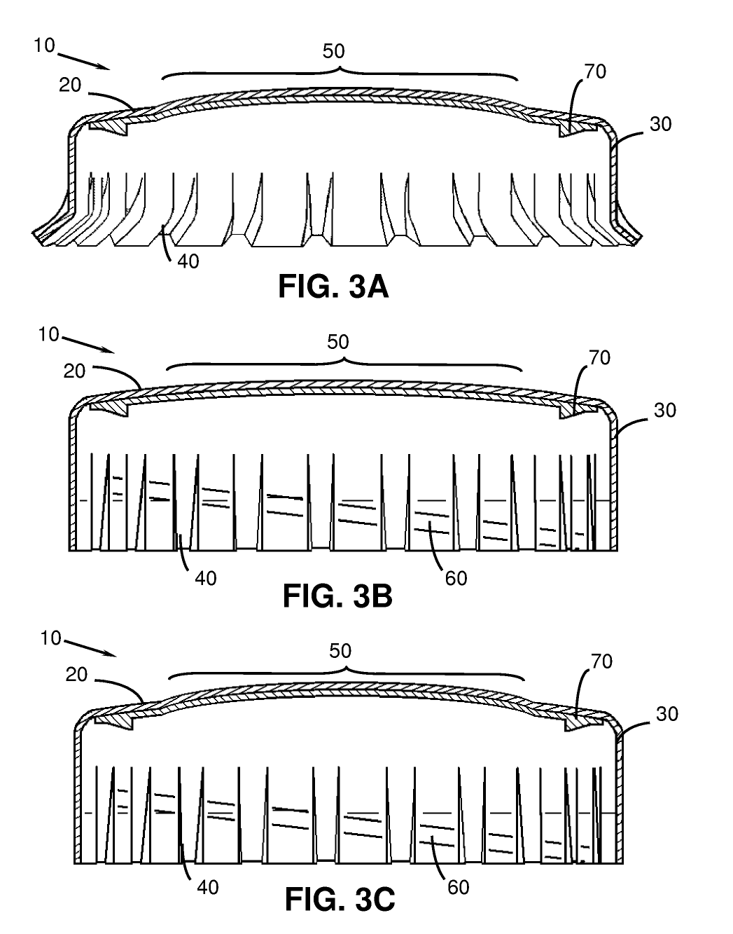

FIGS. 3A, 3B and 3C illustrate a second embodiment of a sequence of state changes of projection 50 for an application of crown-type metal cap 10 to close a beverage bottled under vacuum.

FIG. 3A illustrates a side sectional view of crown-type metal cap 10 once it has been manufactured and before being placed on the mouth of bottle, that is, in its free form, which has been manufactured with the projection 50 in an initial state in convex shape with respect to central body 20. The crown-type metal cap 10 has a liner 70 and the other elements described in the FIG. 1. The projection 50 has a diameter smaller than the diameter of liner 70 to facilitate its manufacturing, operation, and avoiding interference with liner 70, with the bottle (not shown) and with the rest of the crown-type metal cap 10.

FIG. 3B illustrates a side sectional view of crown-type metal cap 10 of the FIG. 3A, once it has been located on the threaded mouth of the bottle (not shown) that contains a beverage under vacuum. Product of the closing or crowning process, and in general simultaneously, the projection 50 changes from an original state in convex shape (see FIG. 3A) to a changed state generally in the same plane of central body 20, this due to the pressure by the beverage on the inner surface of projection 50, creating a characteristic sound similar to “click”, “pop” or “clack”, a visual appearance of projection 50 similar to a mark, generally in circular shape on the surface of central body 20, and a smooth feeling without protuberances when touching the projection 50 and the central body 20.

In an alternative embodiment, the projection 50 in its changed state can obtain an inverse shape to the shape of the original state, that is, if the original state is of convex shape, the changed state becomes the concave shape with respect to the plane of central body 20.

The changed state is maintained as long as there is enough vacuum inside the bottle that exceeds the effort generated by the projection 50 when trying to recover its initial state in convex shape. The vacuum inside the bottle to maintain the changed state of the projection 50 is within a range of about 20.318 kPa (6 inches of mercury) to about 40.636 kPa (12 inches of mercury).

In this second embodiment, the changed state is a visual, auditive and tactile support to the consumer of the product, because it indicates whether the beverage is in proper conditions for consumption; that is, in case the bottle shows its crown-type metal cap 10 with the projection 50 in original state of convex shape, a signal to consumers that the beverage has been handled improperly or that is not optimal conditions of consumption, or alternatively, it may be an indicator for monitoring quality during the process of bottling, as it would be an indication that there is leakage of gas from the beverage as it is not hermetically sealed by the crown-type metal cap 10 on the bottle.

Alternately, during the process of capping or crowning, in the crown-type metal cap 10, particularly in the interior of the peripheral crown 30, threading 60 is formed, thus producing crown-type metal cap 10 in accordance with this invention, but with the “twist-off” function.

FIG. 3C shows a side sectional view of the crown-type metal cap 10 of the FIG. 3B at the moment it has been withdrawn from the bottle, or when the beverage has been handled improperly. Under these conditions, the projection 50 automatically changes from a changed state to the original state in convex shape with a characteristic sound similar to “click”, “pop” or “clack”, a visual appearance of projection 50 in convex shape on the surface of central body 20, and a protuberating feeling when touching the projection 50 with respect to the central body 20. This is because the vacuum on projection 50 has decreased to the extent that it does not prevent projection 50 to recover its original state in convex shape. The visual change of the projection 50 with respect to central body 20, of a changed state to an original state in convex shape is a signal that the bottle has been opened or that perhaps the vacuum has been lost from the bottle, and additionally a sound similar to “click”, “pop” or “clack” will provide another signal.

For every time that the projection 50 changes from original state to the changed state, or vice versa, a sound similar to “click”, “pop” or “clack” is produced in either of the alternative embodiments described above. However, in an alternative embodiment, under the optimal conditions of pressure, diameter of projection 50, depth or height of projection 50 with respect to the plane of the central body 20, and the thickness of the sheet of the crown-type metal cap 10, the number of times where the sound is produced by projection 50 can be controlled and is in a range of 1 to 4 times. In other words, this characteristic indicates that the projection 50 may change as many times as necessary from its original state to the changed state and vice versa, but after a range of 1 to 4 state changes, the sound will no longer be audible, which should be very useful for the consumer, because the visual appearance and touch together with the sound produced would be an indication that the beverage actually has not been tampered or altered, for example, if from a tactile and/or visual perspective the projection 50 is ok, but if there is no sound when removing the crown-type metal cap 10 with projection of the bottle, then the beverage may have been handled incorrectly.

In another alternative embodiment, the crown-type metal cap 10 with projection of this invention can be free of the liner 70.

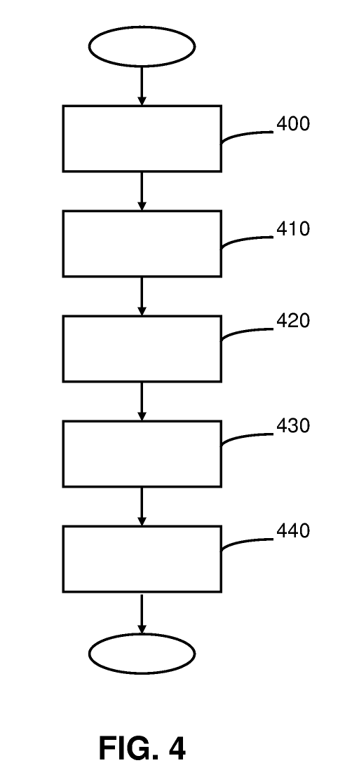

Turning now to the FIG. 4, is illustrate a block diagram of a method for manufacturing a crown-type metal cap with projection according to this invention. First, in step 400, at least one coating of lacquer or pigmented enamel is applied on at least one side of a metal sheet which is printed serially with, for example, the name of the bottler, then drying up at temperature of about 200° C. Later, in step 410, the coated metal sheet is cut in a plurality of disks and shaped into individual metal caps that include a central body and a peripheral crown provided with continual series of grooves that form a single structure with the central body.

Then, in step 420, a liner is applied on the inner surface of each crown-type metal cap. This application of the liner can be produced by introducing measured quantity of the plastisol or organosol or another elastomer substance which may contain vinyl chloride or be free of it, extending over the inner surface, either by turning the crown on itself, or forming it by hot molding die. Next, in step 430, the crown-type metal cap passes to a cooling chamber.

Finally, in step 440, is formed a projection, generally in semi-spherical shape, in the central body of each of the crown-type metal cap, this is done through rowed of each of the crown-type metal caps on a conveyor chain, then enter a rotary press, where the crown-type metal caps receive, by stamping, a deformation in convex or concave shape in the central body. This deformation is caused by tools, which are designed so as not to damage the liner and any other elements of the crown-type metal caps. The projection, generally in semi-spherical shape, in the central body of the metal cap is formed by a stroke and press that allow deforming the central body, thus forming the projection that can operate in an original state in concave or convex shape, that may change to a changed state in the same plane of the central body, or in inverse shape to the shape of the original state with respect to the central body according to the application to which the crown-type metal cap with projection of this invention is designed. This may be to close bottles containing pressurized or vacuum-packed beverages.

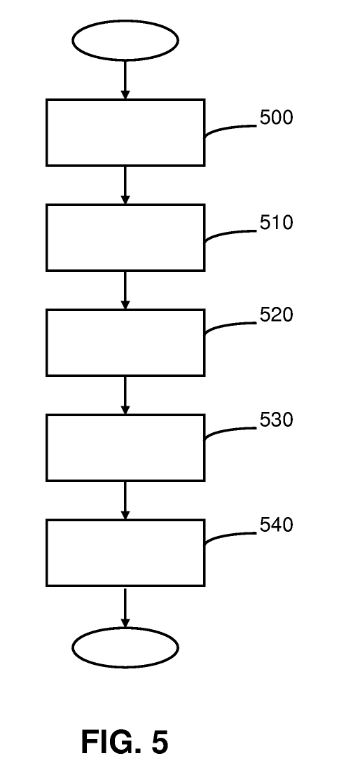

Regarding to the FIG. 5, it is illustrated a block diagram of a method for bottling pressurized beverages with a crown-type metal cap with projection according to this invention. First, in step 500, a number of bottles from a washing machine are driven by a conveyor chain to be fed to a bottling machine; the bottles when entering the bottling machine make a circular route. In a manner generally simultaneous, in step 510, the bottling machine is fed by the beverage to be bottled. Next, in step 520, the filling of the beverage into the bottles in the bottling machine is performed through a system of nozzles that fill the bottle with the beverage that has previously entered into a feed hopper from where it is divided by a set of piping and valves to the nozzles. Then in step 530, once the bottle has been filled, the latter goes to a capping or crowning machine where it is closed under pressure with a crown-type metal cap with projection of this invention (see FIG. 2A), which has previously been fed together with another set of caps that have their projection in a original state in concave shape with respect to the central body, into a feed hopper or crowning machine. At the time the pressurized beverage is closed, the projection of the crown-type metal cap changes to a changed state in the same plane of the central body or in a convex shape with respect to the central body, this as result of the pressure effectuated by the bottled beverage. Simultaneously, in this step, a thread is formed in the interior of the peripheral crown with projection. Finally, in step 540, the filled and closed bottles are driven by a conveyor chain towards the process of packing and stowing.

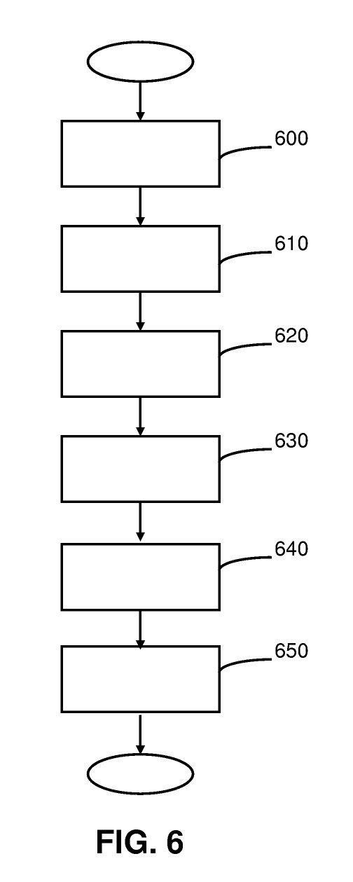

Turning now to the FIG. 6, it is illustrated a block diagram of a method for bottling vacuum beverages with a crown-type metal cap with projection according to this invention. First, in step 600, a number of bottles from a washing machine are driven by a conveyor chain to be fed to a bottling machine; the bottles when entering the bottling machine make a circular route. In a manner generally simultaneous, in step 610, the bottling machine is fed by the beverage to be bottled. Next, in step 620, the filling of the beverage into the bottles in the bottling machine is performed through a system of nozzles that fill the bottle with the beverage that has previously entered into a feed hopper from where it is divided by a set of piping and valves to the nozzles. Then, in step 630, once the bottle has been filled, the latter goes to a capping or crowning machine where it is closed under pressure with a crown-type metal cap with projection of this invention (see FIG. 3A), which has previously been fed together with another set of caps that have their projection in a original state in convex shape with respect to the central body, into the feed hopper or crowning machine. Later, in step 640, the bottles pass to the process for generating a vacuum inside, where the projection of the crown-type metal cap changes to a changed state in the same plane of the central body or in concave shape with respect to the central body, this as a result of the existing vacuum in the bottled beverage. Simultaneously, in this step, a thread is formed in the interior of the peripheral crown with a projection. Finally, in step 650, the bottles are filled and capped, and driven by the conveyor belt towards the process of packing and stowing.

Based on the alternative embodiments described above, the modifications to the embodiments described, as well as the applications and alternative embodiments will be considered obvious to any person skilled in the art of the technique under this description. It is therefore considered that the claims cover such modifications and alternatives falling within the scope of the present invention.

1. A crown-type metal cap comprising:
a central body;
a peripheral crown having a continuous series of grooves forming a single structure with said central body; and
a projection in said central body
operating in an original state and in a changed state with respect to said central body, and wherein said projection in change state is located in the same plane of said central body.

2. The crown-type metal cap of claim 1 wherein said projection is substantially of semi-spherical shape with respect to the plane of said central body when it is in its original state.

3. The crown-type metal cap of claim 1 wherein said projection is substantially of circular shape with respect to the plane of said central body when it is in its changed state.

4. The crown-type metal cap of claim 1 wherein said projection operates in an original state of concave shape and in a changed state with respect to said central body, wherein said original state of concave shape is when said crown-type metal cap is free or closing a bottle inside which there is not enough pressure, and wherein said change state is when said crown-type metal cap closes a bottle inside which there is pressure.

5. The crown-type metal cap of claim 4 wherein said pressure inside the bottle for maintaining said changed state of the projection is of 68.9475 kPa (10 psi) to 1378.9514 kPa (200 psi).

6. The crown-type metal cap of claim 1 wherein said projection operates in an original state of convex shape and in a changed state with respect to said central body, wherein said original state of convex shape is when said crown-type metal cap is free or closing a bottle inside which there is no vacuum, and wherein said changed state is when said crown-type metal cap closes a bottle inside in which there is vacuum.

7. The crown-type metal cap of claim 6 wherein said vacuum inside the bottle for maintaining said changed state of the projection is of 20.318 kPa (6 inches of mercury) to 40.636 kPa (12 inches of mercury).

8. The crown-type metal cap of claim 1 wherein further includes a liner.

9. The crown-type metal cap of claim 8 wherein said projection has a diameter smaller than the diameter of said liner.

10. The crown-type metal cap of claim 1 wherein said metal cap has a thickness sheet of 0.1778 mm (0.007 in) to 0.26 mm (0.01 in).

11. The crown-type metal cap of claim 1 wherein said projection has a diameter of 6.35 mm (0.25 in) to 18.415 mm (0.725 in).

12. The crown-type metal cap of claim 1 wherein said projection has a depth or height in its center, with respect to the plane of said central body, of 0.127 mm (0.005 in) to 1.778 mm (0.070 in).

13. The crown-type metal cap of claim 1 wherein each change from said original changed state to said changed state or vice versa, produces a sound similar to “clic”, “pop” or “clack”.

14. The crown-type metal cap of claim 13 wherein the amount of times that said sound is audible is of 1 to 4 changes of state.

15. The crown-type metal cap of claim 1 wherein said peripheral crown includes a thread that is formed when said crown-type metal cap closes a bottle with a threaded mouth.

16. A method for manufacturing crown-type metal caps with projection, the method comprising the steps of:
applying at least one coating on at least one side of a metal sheet;
cutting and shaping said coated metal sheet into individual crown-type metal caps which including a central body and a peripheral crown provided with a continuous series of grooves forming a single structure with said central body; and
forming a projection in said central body of each of said metal caps.

17. The method of claim 16 wherein further said step of cutting and forming said coated metal sheet into individual crown-type metal caps includes the step of forming a liner in said crown-type metal caps.

18. The method of claim 17 wherein said projection has a diameter smaller than the diameter of said liner.

19. The method of claim 16 wherein said projection is substantially of semi-spherical shape with respect to the plane of said central body.

20. The method of claim 16 wherein said projection operates in an original state of concave shape and in a changed state with respect to said central body, wherein said original state of concave shape is when said crown-type metal cap is free or closing a bottle inside which there is not enough pressure, and wherein said change state is when said crown-type metal cap closes a bottle inside which there is pressure.

21. The method of claim 20 wherein said pressure inside the bottle for maintaining said changed state of the projection is of 68.9475 kPa (10 psi) to 1378.9514 kPa (200 psi).

22. The method of claim 16 wherein said projection operates in an original state of convex shape and in a changed state with respect to said central body, wherein said original state of convex shape is when said crown-type metal cap is free or closing a bottle inside which there is no vacuum, and wherein said changed state is when said crown-type metal cap closes a bottle inside in which there is vacuum.

23. The method of claim of claim 22 wherein said vacuum inside the bottle for maintaining said changed state of the projection is of 20.318 kPa (6 inches of mercury) to 40.636 kPa (12 inches of mercury).

24. The method of claims 20 and 22 wherein each change from said original changed state to said changed state or vice versa, produces a sound similar to “clic”, “pop” or “clack”.

25. The method of claim 16 wherein the amount of times that said sound is audible is of 1 to 4 changes of state.

26. The method of claim 16 wherein said metal cap has a thickness sheet of 0.1778 mm (0.007 in) to 0.26 mm (0.01 in).

27. The method of claim 16 wherein said projection has a diameter of 6.35 mm (0.25 in) to 18.415 mm (0.725 in).

28. The method of claim 16 wherein said projection has a depth or height in its center, with respect to the plane of said central body, of 0.127 mm (0.005 in) to 1.778 mm (0.070 in).

29. The method of claim 16 wherein further includes the step of forming a thread on said peripheral crown at the moment when said crown-type metal cap closes a bottle with a threaded mouth.

30-55. (canceled)
